(19) United States
(12) Patent Application Publication
(10) Pub. No.: US 2009/0276210 A1
(43) Pub. Date: Nov. 5, 2009

(54) STEREO AUDIO ENCODING APPARATUS, STEREO AUDIO DECODING APPARATUS, AND METHOD THEREOF

(75) Inventors: Michiyo Goto, Tokyo (JP); Koji Yoshida, Kanagawa (JP)

Correspondence Address: GREENBLUM & BERNSTEIN, P.L.C., 1950 ROLAND CLARKE PLACE, RESTON, VA, 20191, US

(73) Assignee: PANASONIC CORPORATION, Osaka (JP)

(21) Appl. No.: 12/295,073

(22) PCT Filed: Mar. 29, 2007
(86) PCT No.: PCT/JP2007/056955

§ 371 Date: Sep. 29, 2008

(30) Foreign Application Priority Data
Mar. 31, 2006 (JP) 2006-099913
Oct. 3, 2006 (JP) 2006-272132

(51) Int. Cl. G10L 19/14

(52) U.S. Cl. 704/211

(57) ABSTRACT

Disclosed is a stereo speech decoding device and others capable of reducing a stereo speech encoding bit rate and suppressing degradation of speech quality. In this device, a section 0 where only an L-channel signal S_{L}(n) exists is identified, a monaural signal of the section 0 transmitted from the stereo speech encoding side is made to be an L-channel signal of section 0 S_{L}⁽⁰⁾(n), and the L-channel signal S_{L}⁽⁰⁾(n) of the section 0 is scale-adjusted so as to predict an R-channel signal S_{R}⁽¹⁾(n) of a section 1. A contribution of the R-channel signal S_{R}⁽¹⁾(n) of the predicted section 1 is subtracted from the monaural signal of the section 1 so as to isolate the L-channel signal S_{L}⁽¹⁾(n) of the section 1. This device continuously repeats the aforementioned scale adjustment and isolation process so as to obtain the L-channel signal S_{L}(n) and the R-channel signal S_{R}(n) of all the sections.

### TECHNICAL FIELD

The present invention relates to a stereo speech encoding apparatus that performs encoding for a stereo speech signal, a stereo speech decoding apparatus corresponding thereto, and a method thereof.

### BACKGROUND ART

Communication by means of a monaural scheme (monaural communication) is currently the mainstream in speech communication in a mobile communication system, such as telephony by means of mobile phones. However, as even higher transmission bit rates are achieved in the future, such as with fourth-generation mobile communication systems, communication by means of a stereo scheme (stereo communication) is expected to become widespread in speech communication due to the ability to secure a band allowing transmission of a plurality of channels.

For example, considering the current situation in which growing numbers of users record music in a portable audio player with a built-in HDD (hard disk drive), and enjoy stereo music by plugging stereo earphones or headphones into the player, a future lifestyle can be envisaged in which it is common practice to perform stereo speech communication using stereo earphones, headphones, or suchlike equipment with a combined mobile phone/music player. Also, in a currently increasingly popular video-conferencing environment, the use of stereo communication can be envisaged as a way of achieving more realistic conferences.

Meanwhile, in mobile communication systems, cable communication systems, and so forth, a lower transmission information bit rate is typically achieved by pre-encoding a transmitted speech signal in order to reduce the system load. Consequently, technologies for encoding a stereo speech signal have recently been attracting attention. For example, there is a technology whereby one channel signal composing a stereo signal is predicted from the other channel signal using Equation (1) below, and prediction parameters aₖ and d are encoded (see Non-patent Document 1).

$$\begin{matrix}( Equation 1 ) & \\ {y}^{\hat{}} ( n ) = {\sum }_{k = 0}^{K} {a}_{k}^{⋆} x ( n - d - k ) & [ 1 ]\end{matrix}$$

Here, aₖ is a k-th order prediction coefficient functioning as a prediction parameter that minimizes prediction error, d represents the delay time difference of two channel signals, x(n) represents one channel signal in sample number n, and ŷ(n) represents the other channel signal predicted in sample number n.

Even with the spread of stereo communication, it is envisaged that monaural communication will still continue to be performed. The reason is that monaural communication is expected to offer lower communication costs because of the low bit rate, while mobile phones supporting only monaural communication will be less expensive due to the smaller circuit scale, and users not requiring high-quality speech communication will probably purchase mobile phones supporting only monaural communication. A single communication system will thus include a mix of mobile phones supporting stereo communication and mobile phones supporting monaural communication, and it will be necessary for a communication system to support both stereo communication and monaural communication. Furthermore, in a mobile communication system, depending on the propagation environment there may be some loss of communication data due to the fact that communication data is exchanged by means of radio communication. Thus, it is extremely useful for a mobile phone to be provided with a function enabling the original communication data to be reconstituted from receive data remaining after some communication data is lost.

A function that enables both stereo communication and monaural communication to be supported, and also allows reconstitution of original communication data from receive data remaining after some communication data is lost, is scalable encoding enabling both a stereo signal and a monaural signal to be encoded and decoded. An example of a scalable encoding apparatus having this function is disclosed in Non-patent Document 2, for instance.

Non-patent Document 1: Hendrik Fuchs, “Improving Joint Stereo Audio Coding by Adaptive Inter-Channel Prediction”, Applications of Signal Processing to Audio and Acoustics, Final Program and Paper Summaries, IEEE Workshop on Pages:39-42, (17-20 Oct. 1993)
Non-patent Document 2: ISO/IEC 14496-3:1999 (B.14 Scalable AAC with core coder)

### DISCLOSURE OF INVENTION

### Problems to be Solved by the Invention

However, a problem with the technology disclosed in Non-patent Document 1 is that, if encoding is performed based on the kind of prediction indicated by above Equation (1) and the prediction coefficient order is raised—that is, the number of prediction parameters is increased—in order to reduce prediction error, the encoding bit rate increases. Also, conversely, if the prediction coefficient order is reduced in order to suppress the encoding bit rate, there is a problem in that prediction performance declines, and perceptual speech quality degradation occurs in an speech signal obtained on the decoding side. Moreover, if the technology of Non-patent Document 1 is applied to scalable encoding of the kind disclosed in Non-patent Document 2, it is necessary to find a prediction coefficient not only for a stereo signal but also for a monaural signal, and the encoding bit rate further increases.

It is an object of the present invention to provide a stereo speech encoding apparatus, stereo speech decoding apparatus, and method thereof that enable the bit rate to be reduced and degradation of speech quality to be suppressed by encoding and transmitting a smaller quantity of information.

### Means for Solving the Problems

A stereo speech decoding apparatus of the present invention employs a configuration having: a monaural signal decoding section that decodes encoded information in which a monaural signal in which a temporally-preceding preceding channel signal and a temporally-succeeding succeeding channel signal of a stereo speech signal composed of two channels are combined is encoded; an onset position decoding section that decodes encoded information in which an onset position at which a change is made from an inactive speech section to an active speech section of the stereo speech signal is encoded; a delay time difference decoding section that decodes encoded information in which a delay time difference between the preceding channel signal and succeeding channel signal is encoded; an amplitude ratio decoding section that decodes encoded information in which an amplitude ratio between the succeeding channel signal and the preceding channel signal is encoded; a preceding channel signal decoding section that decodes the preceding channel signal using the monaural signal, the delay time difference, and the onset position; and a succeeding channel signal decoding section that decodes the succeeding channel signal using the preceding channel signal and the amplitude ratio.

### Advantageous Effect of the Invention

According to the present invention, in stereo speech encoding the bit rate can be reduced and degradation of speech quality can be suppressed by encoding and transmitting a smaller quantity of information relating to the stereo signal onset position and the delay time difference and amplitude ratio between both channels, without encoding a prediction coefficient between both channels.

### BRIEF DESCRIPTION OF DRAWINGS

FIG. 1 is a block diagram showing the main configuration of a stereo speech encoding apparatus according to Embodiment 1;

FIG. 2 is a drawing for explaining an onset position of a stereo speech signal according to Embodiment 1;

FIG. 3 is a drawing for explaining a delay time difference and amplitude ratio between an L-channel signal and R-channel signal according to Embodiment 1;

FIG. 4 is a block diagram showing the main configuration of a stereo speech decoding apparatus according to Embodiment 1;

FIG. 5 is a block diagram showing the detailed configuration of a stereo signal decoding section according to Embodiment 1;

FIG. 6 is a drawing for explaining the principle of stereo speech signal decoding processing in a stereo speech decoding apparatus according to Embodiment 1;

FIG. 7 is a drawing summarizing stereo speech signals according to Embodiment 1 in a table;

FIG. 8 is a block diagram showing the main configuration of a stereo speech encoding apparatus according to Embodiment 2;

FIG. 9 is a block diagram showing the detailed configuration of a second layer decoder according to Embodiment 2;

FIG. 10 is a block diagram showing the main configuration of a stereo speech decoding apparatus according to Embodiment 2;

FIG. 11 is a block diagram showing the main configuration of a stereo speech encoding apparatus according to Embodiment 3; and

FIG. 12 is a block diagram showing the main configuration of a stereo speech encoding apparatus according to Embodiment 4.

### BEST MODE FOR CARRYING OUT THE INVENTION

Embodiments of the present invention will now be described in detail with reference to the accompanying drawings. In the following description, a case will be described by way of example in which a stereo speech signal composed of two channels, an L-channel and R-channel, is encoded.

### Embodiment 1

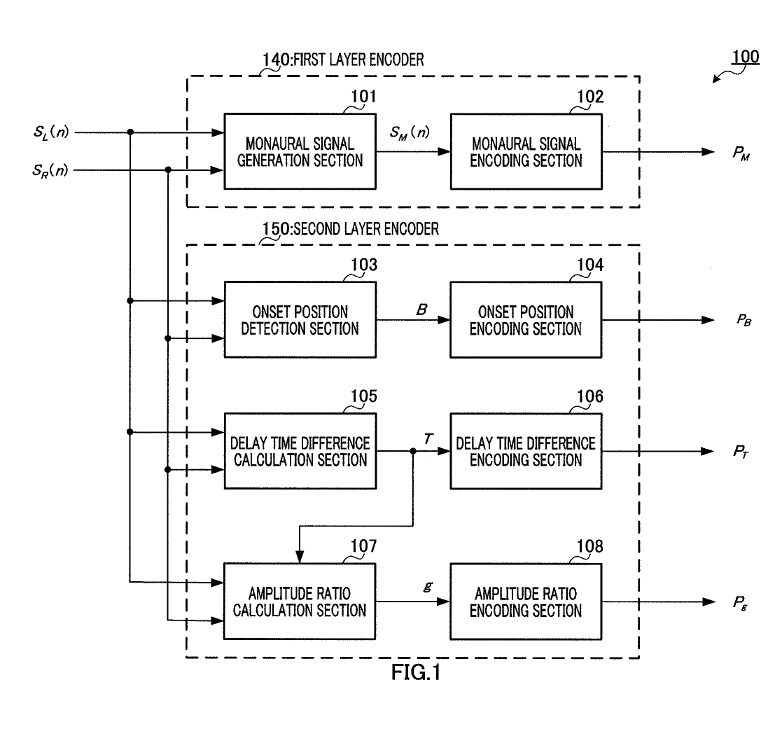

FIG. 1 is a block diagram showing the main configuration of stereo speech encoding apparatus 100 according to Embodiment 1 of the present invention.

In FIG. 1, stereo speech encoding apparatus 100 is provided with first layer (base layer) encoder 140 and second layer (enhancement layer) encoder 150, and performs scalable encoding of a stereo speech signal. First layer encoder 140 is provided with monaural signal generation section 101 and monaural signal encoding section 102, and performs monaural signal encoding. Second layer encoder 150 is provided with onset position detection section 103, onset position encoding section 104, delay time difference calculation section 105, delay time difference encoding section 106, amplitude ratio calculation section 107, and amplitude ratio encoding section 108, and performs stereo signal encoding. Each layer encoder transmits an obtained encoding parameter to stereo speech decoding apparatus 200 described later herein.

Monaural signal generation section 101 generates monaural signal S_{M}(n) from an input stereo speech signal—that is, L-channel signal S_{L}(n) and R-channel signal S_{R}(n)—and outputs this signal to monaural signal encoding section 102. Monaural signal S_{M}(n) is generated by finding the average value of L-channel signal S_{L}(n) and R-channel signal S_{R}(n) in accordance with Equation (2) below.

S_{M}(n)=(S_{L}(n)+S_{R}(n))/2 (Equation 2)

Here, n indicates a stereo speech signal sample number.

Monaural signal encoding section 102 encodes monaural signal S_{M}(n) generated by monaural signal generation section 101 by means of a CELP (Code Excited Linear Prediction) encoding method, and transmits obtained monaural signal encoding parameter P_{M} to stereo speech decoding apparatus 200. In the CELP encoding method, an LSP parameter is found and encoded for vocal tract information of speech signal, while for excitation information of speech signal, a previously stored speech model is identified, and encoding is performed by means of an index indicating the identified speech model.

From L-channel signal S_{L}(n) and R-channel signal S_{R}(n) input to stereo speech encoding apparatus 100, second layer encoder 150 finds and encodes an onset position, a delay time difference between L-channel signal S_{L}(n) and R-channel signal S_{R}(n), and an amplitude ratio between L-channel signal S_{L}(n) and R-channel signal S_{R}(n), and transmits obtained encoding parameters P_{B}, P_{T}, and P_{g} to stereo speech decoding apparatus 200.

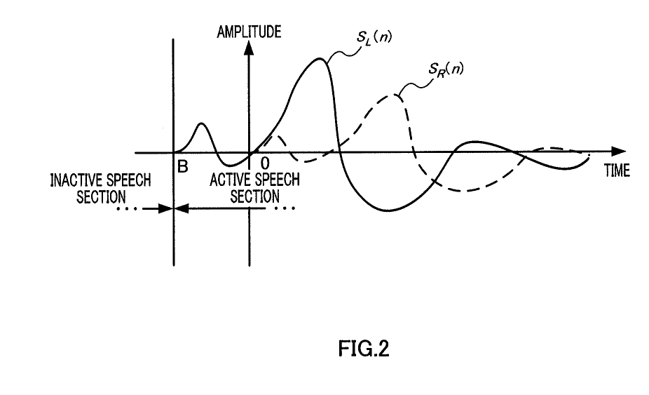

Onset position detection section 103 detects a stereo speech signal onset position from input L-channel signal S_{L}(n) and R-channel signal S_{R}(n). The stereo speech signal onset position will now be explained with reference to FIG. 2.

Normally, an inactive speech section in which the speech signal amplitude is zero and an active speech section in which the speech signal is non-zero are present in a stereo speech signal. A position at which a speech signal transits from an inactive speech section to an active speech section is called onset position B. L-channel signal S_{L}(n) and R-channel signal S_{R}(n) in which a signal generated by the same source is acquired at different positions are at different distances from the source, and therefore one channel signal precedes and becomes the preceding channel, while the other channel signal becomes the succeeding channel and has an amplitude attenuated from the amplitude of the preceding channel signal. For example, in this embodiment L-channel signal S_{L}(n) is nearer to the source than R-channel signal S_{R}(n), and thus also precedes R-channel signal S_{R}(n) temporally, and has greater amplitude. Therefore, in a predetermined section from the onset position, R-channel signal S_{R}(n) is not present and only L-channel signal S_{L}(n) is present. In FIG. 2, the start position of a section in which the amplitude of L-channel signal S_{L}(n) and the amplitude of R-channel signal S_{R}(n) are both non-zero is indicated by 0 on the time axis.

Onset position detection section 103 detects a position at which an inactive speech section ends and a section in which only an L-channel signal is present as onset position B, and outputs information relating to detected onset position B to onset position encoding section 104. Here, information relating to onset position B includes both information identifying whether the preceding channel signal nearer to the source is the L-channel signal or the R-channel signal, and information indicating the position at which the amplitude of the preceding channel changes from zero to non-zero.

Onset position encoding section 104 encodes information relating to onset position B input from onset position detection section 103, and transmits obtained onset position encoding parameter P_{B} to stereo speech decoding apparatus 200.

Using L-channel signal S_{L}(n) and R-channel signal S_{R}(n) input to stereo speech encoding apparatus 100, delay time difference calculation section 105 calculates delay time difference T between L-channel signal S_{L}(n) and R-channel signal S_{R}(n) in accordance with Equation (3) below.

$$\begin{matrix}( Equation 3 ) & \\ φ ( m ) = {\sum }_{n = 0}^{N - 1} {S}_{L} ( n - m ) \cdot {S}_{R} ( n ) & [ 2 ]\end{matrix}$$

Here, φ(m) indicates a cross-correlation function for L-channel signal S_{L}(n) and R-channel signal S_{R}(n), N indicates the number of samples contained in one frame, and m indicates the number of shift samples of R-channel signal S_{R}(n) with respect to L-channel signal S_{L}(n). Delay time difference calculation section 105 calculates the value of m for which the value of φ(m) is maximum as delay time difference T between L-channel signal S_{L}(n) and R-channel signal S_{R}(n). When L-channel signal S_{L}(n) precedes R-channel signal S_{R}(n), the value of T is positive, and when L-channel signal S_{L}(n) succeeds R-channel signal S_{R}(n), the value of T is negative. As stated above, a case in which L-channel signal S_{L}(n) precedes R-channel signal S_{R}(n) is being considered here as an example, and therefore the value of T is positive. Delay time difference calculation section 105 outputs calculated delay time difference T to delay time difference encoding section 106 and amplitude ratio calculation section 107.

Delay time difference encoding section 106 encodes delay time difference T input from delay time difference calculation section 105, and transmits encoding parameter P_{T} to stereo speech decoding apparatus 200.

Using L-channel signal S_{L}(n) and R-channel signal S_{R}(n) input to stereo speech encoding apparatus 100 and delay time difference T calculated by delay time difference calculation section 105, amplitude ratio calculation section 107 calculates amplitude ratio g between L-channel signal S_{L}(n) and R-channel signal S_{R}(n) in accordance with Equation (4) below.

$$\begin{matrix}( Equation 4 ) & \\ g = \frac{{A}_{R}}{{A}_{L}} = \sqrt{\frac{{\sum }_{n = 0}^{N - 1} {{S}_{R} ( n )}^{2}}{{\sum }_{n = 0}^{N - 1} {{S}_{L} ( n - T )}^{2}}} & [ 3 ]\end{matrix}$$

Here, A_{R} and A_{L} indicate the average amplitude in one frame of R-channel signal S_{R}(n) and L-channel signal S_{L}(n) respectively. Amplitude ratio calculation section 107 outputs calculated amplitude ratio g to amplitude ratio encoding section 108.

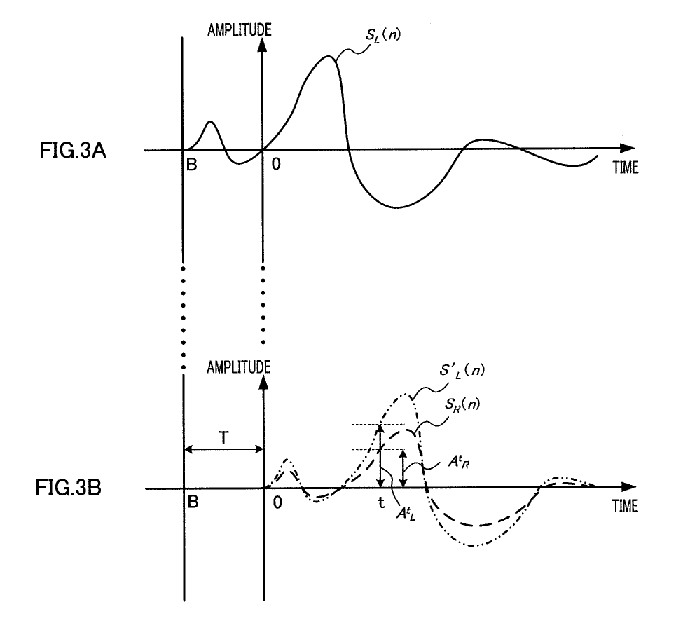

Delay time difference T and amplitude ratio g between L-channel signal S_{L}(n) and R-channel signal S_{R}(n) calculated by delay time difference calculation section 105 and amplitude ratio calculation section 107 respectively will now be explained using FIG. 3.

FIG. 3 is a drawing showing a delay time difference and amplitude ratio between L-channel signal S_{L}(n) and R-channel signal S_{R}(n) in which a signal generated by the same source is acquired at different positions. In this drawing, FIG. 3A indicates L-channel signal S_{L}(n), and FIG. 3B indicates the relationship between R-channel signal S_{R}(n) and L-channel signal S_{L}(n). As shown in this drawing, when L-channel signal S_{L}(n) is delayed by delay time difference T calculated by delay time difference calculation section 105, it becomes signal S′_{L}(n). Here, the signal length from onset position B to time axis point 0 is identical to delay time difference T. Next, when the amplitude of signal S′_{L}(n) is multiplied by amplitude ratio g calculated by amplitude ratio calculation section 107, signal S′_{L}(n), being a signal generated by the same source, ideally coincides with R-channel signal S_{R}(n). For example, in this drawing, A^{t}_{R} and A^{t}_{L} indicate the amplitude of R-channel signal S_{R}(n) and the amplitude of L-channel signal S_{L}(n) corresponding to time t respectively, satisfying the relationship A^{t}_{R}/A^{t}_{L}=g.

Amplitude ratio encoding section 108 encodes amplitude ratio g input from amplitude ratio calculation section 107, and transmits obtained encoding parameter P_{g} to stereo speech decoding apparatus 200.

As described above, encoding processing in stereo speech encoding apparatus 100 is performed in frame units, and monaural signal encoding parameter P_{M}, onset position encoding parameter P_{B}, delay time difference encoding parameter P_{T}, and amplitude ratio encoding parameter P_{g} are generated and transmitted to stereo speech decoding apparatus 200.

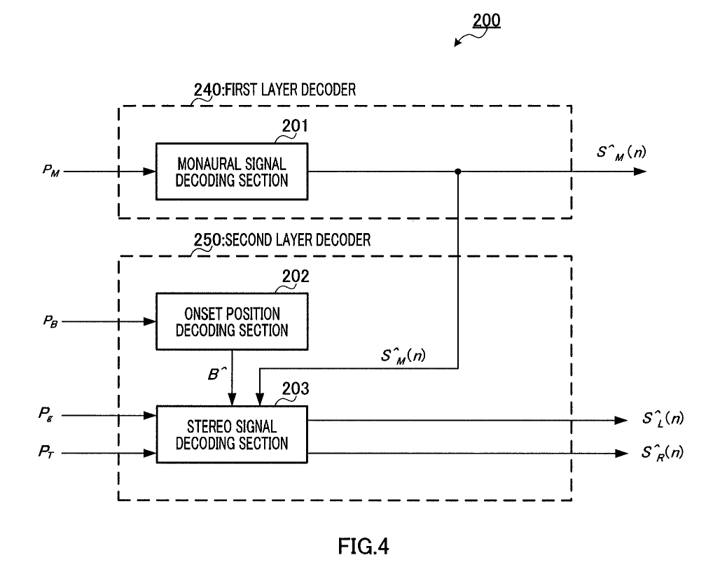

FIG. 4 is a block diagram showing the main configuration of stereo speech decoding apparatus 200 according to this embodiment.

In FIG. 4, stereo speech decoding apparatus 200, corresponding to stereo speech encoding apparatus 100, is provided with first layer (base layer) decoder 240 and second layer (enhancement layer) decoder 250. First layer decoder 240 is provided with monaural signal decoding section 201, and performs monaural signal decoding in frame units using monaural signal encoding parameter P_{M} transmitted from stereo speech encoding apparatus 100. Second layer decoder 250 is provided with onset position decoding section 202 and stereo signal decoding section 203, and performs stereo signal decoding in delay time difference T units using onset position encoding parameter P_{B}, delay time difference encoding parameter P_{T}, and amplitude ratio encoding parameter P_{g} transmitted from stereo speech encoding apparatus 100.

In first layer decoder 240, monaural signal decoding section 201 performs monaural signal decoding using monaural signal encoding parameter P_{M} transmitted from monaural signal encoding section 102 of stereo speech encoding apparatus 100, and outputs monaural decoded signal Ŝ_{M}(n). Here, a CELP decoding method corresponding to the encoding method used by monaural signal encoding section 102 is used as the monaural signal decoding section 201 decoding method. If stereo signal decoding is not performed in second layer decoder 250, a stereo speech decoded signal generated by stereo speech decoding apparatus 200 is monaural decoded signal Ŝ_{M}(n) only, a monaural speech signal. Monaural signal decoding section 201 outputs monaural decoded signal Ŝ_{M}(n) to stereo signal decoding section 203.

In second layer decoder 250, onset position decoding section 202 decodes onset position encoding parameter P_{B} transmitted from onset position encoding section 104 of stereo speech encoding apparatus 100, and outputs decoded onset position B̂ to stereo signal decoding section 203. Stereo signal decoding section 203 performs stereo signal decoding using amplitude ratio encoding parameter P_{g} transmitted from amplitude ratio encoding section 108 of stereo speech encoding apparatus 100, delay time difference encoding parameter P_{T} transmitted from delay time difference encoding section 106 of stereo speech encoding apparatus 100, monaural decoded signal Ŝ_{M}(n) input from monaural signal decoding section 201, and decoded onset position B̂ input from onset position decoding section 202, and outputs L-channel decoded signal Ŝ_{L}(n) and R-channel decoded signal Ŝ_{R}(n).

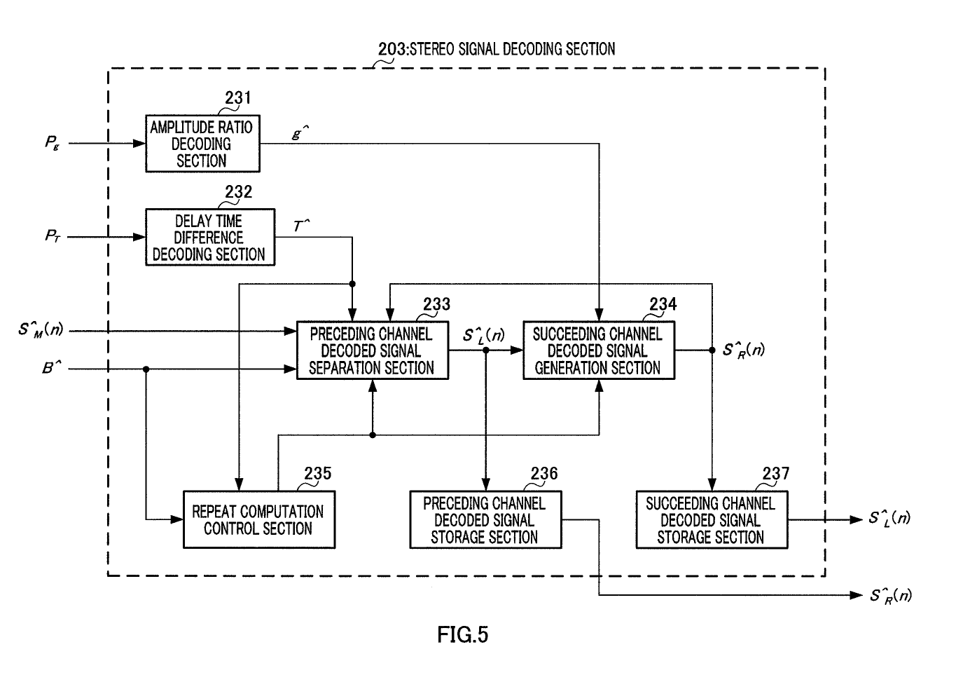

FIG. 5 is a block diagram showing the detailed configuration of stereo signal decoding section 203 according to this embodiment.

In FIG. 5, stereo signal decoding section 203 is provided with amplitude ratio decoding section 231, delay time difference decoding section 232, preceding channel decoded signal separation section 233, succeeding channel decoded signal generation section 234, repeat computation control section 235, preceding channel decoded signal storage section 236, and succeeding channel decoded signal storage section 237.

Amplitude ratio decoding section 231 decodes amplitude ratio encoding parameter P_{g} transmitted from amplitude ratio encoding section 108 of stereo speech encoding apparatus 100, and outputs obtained decoded amplitude ratio ĝ to succeeding channel decoded signal generation section 234.

Delay time difference decoding section 232 decodes delay time difference encoding parameter P_{T} transmitted from delay time difference encoding section 106 of stereo speech encoding apparatus 100, and outputs obtained decoded delay time difference T̂ to preceding channel decoded signal separation section 233 and repeat computation control section 235.

Preceding channel decoded signal separation section 233 separates preceding channel decoded signal Ŝ_{L}(n) from monaural decoded signal Ŝ_{M}(n) using monaural decoded signal Ŝ_{M}(n) input from monaural signal decoding section 201, decoded delay time difference T̂ input from delay time difference decoding section 232, decoded onset position B̂ input from onset position decoding section 202, and succeeding channel decoded signal Ŝ_{R}(n) input from succeeding channel decoded signal generation section 234. As described above, in this embodiment the L-channel is the preceding channel and the R-channel is the succeeding channel. In the above separation processing, preceding channel decoded signal separation section 233 repeats the same kind of computation in all sections based on control by repeat computation control section 235. Preceding channel decoded signal separation section 233 outputs obtained L-channel decoded signal Ŝ_{L}(n) to succeeding channel decoded signal generation section 234 and preceding channel decoded signal storage section 236.

Using decoded amplitude ratio ĝ input from amplitude ratio decoding section 231 and L-channel decoded signal Ŝ_{L}(n) input from preceding channel decoded signal separation section 233, succeeding channel decoded signal generation section 234 generates a succeeding channel decoded signal—that is, in this embodiment, R-channel decoded signal Ŝ_{R}(n). In the above processing, succeeding channel decoded signal generation section 234 repeats the same kind of computation in all sections based on control by repeat computation control section 235. Succeeding channel decoded signal generation section 234 outputs generated R-channel decoded signal Ŝ_{R}(n) to preceding channel decoded signal separation section 233 and succeeding channel decoded signal storage section 237.

Using decoded delay time difference T̂ input from delay time difference decoding section 232 and decoded onset position B̂ input from onset position decoding section 202, repeat computation control section 235 controls repeated computation by preceding channel decoded signal separation section 233 and succeeding channel decoded signal generation section 234, and causes generation of L-channel decoded signal Ŝ_{L}(n) and R-channel decoded signal Ŝ_{R}(n) in decoded delay time difference T̂ (hereinafter regarded as delay time difference T) units.

Preceding channel decoded signal storage section 236 and succeeding channel decoded signal storage section 237 respectively store L-channel decoded signal Ŝ_{L}(n) and R-channel decoded signal Ŝ_{R}(n) input respectively from preceding channel decoded signal separation section 233 and succeeding channel decoded signal generation section 234, and compose a stereo speech decoded signal by simultaneously outputting L-channel decoded signal Ŝ_{L}(n) and R-channel decoded signal Ŝ_{R}(n) corresponding to the same delay time difference T unit.

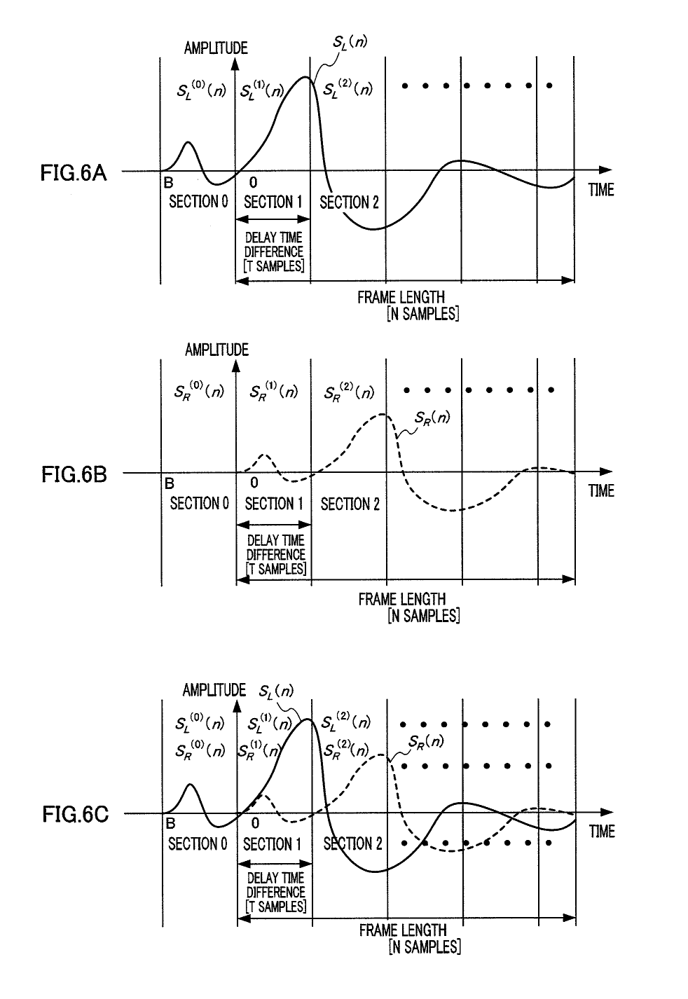

The principle whereby the respective channel signals can be separated in stereo speech signal decoding processing by stereo speech decoding apparatus 200 will now be explained using FIG. 6.

In FIG. 6, S_{L}(n) and S_{R}(n) indicate an L-channel signal and R-channel signal respectively, and n indicates a sample number. One frame is composed of N samples. In FIG. 6A L-channel signal S_{L}(n) is indicated by a solid line, in FIG. 6B R-channel signal S_{R}(n) is indicated by a dotted line, and in FIG. 6C L-channel signal S_{L}(n) and R-channel signal S_{R}(n) are indicated simultaneously by a solid line and dotted line.

As shown in FIG. 6A, in this embodiment a case in which delay time difference T is shorter than one frame length is taken as an example, and a section from onset position B to initial delay time difference T is shown as section 0. In FIG. 6A, one frame of L-channel signal S_{L}(n) is divided into section 1, section 2, . . . every delay time difference T. Here, the L-channel signal of each section is indicated by S_{L}⁽¹⁾(n), S_{L}⁽²⁾(n), . . . , where superscript characters (1) and (2) indicate the section number. The frame length is not limited to an integral multiple of delay time difference T, and therefore the last section in a frame may be shorter than delay time difference T.

As shown in FIG. 6B, one frame of R-channel signal S_{R}(n) is also divided into section 1, section 2, . . . every delay time difference T, and the R-channel signal of each section is indicated by S_{R}⁽¹⁾(n), S_{R}⁽²⁾(n), . . . , where superscript characters (1) and (2) indicate the section number. R-channel signal S_{R}(n) is not present in section 0 from onset position B to initial delay time difference T. That is to say, S_{R}⁽⁰⁾(n)=0.

Therefore, in accordance with Equation (5) below, stereo speech decoding apparatus 200 can take signal Ŝ_{M}⁽⁰⁾(n) of a part corresponding to section 0 of monaural decoded signal Ŝ_{M}(n) as L-channel decoded signal Ŝ_{L}⁽⁰⁾(n) of section 0.

Ŝ_{L}^{(O)}(n)=Ŝ_{M}⁽⁰⁾(n), where −T≦n<0 (Equation 5)

As shown in FIG. 6C, the waveform of R-channel signal S_{R}(n) indicated by a dotted line is extended by delay time difference T with respect to L-channel signal S_{L}(n) indicated by a solid line, and is one section later. Also, the amplitude of R-channel signal S_{R}(n) is an amplitude resulting from L-channel signal S_{L}(n) being multiplied by amplitude ratio g (where g≦1). That is to say, L-channel signal S_{L}(n) and R-channel signal S_{R}(n) satisfy the relationship shown in Equation (6) below.

S_{R}(n)=g·S_{L}(n−T) (Equation 6)

Therefore, using Equation (7) below, stereo speech decoding apparatus 200 can perform scale adjustment of section 0 L-channel decoded signal Ŝ_{L}⁽⁰⁾(n−T) and find section 1 R-channel signal S_{R}⁽¹⁾(n).

Ŝ_{R}⁽¹⁾(n)=ĝ·Ŝ_{L}⁽⁰⁾(n−T), where 0≦n<T (Equation 7)

Next, section 1 L-channel decoded signal Ŝ_{L}⁽¹⁾(n) can be found by separating above section 1 R-channel decoded signal Ŝ_{R}⁽¹⁾(n) from signal Ŝ_{M}⁽¹⁾(n) of a part corresponding to section 1 of monaural decoded signal Ŝ_{M}(n). When found section 1 L-channel decoded signal Ŝ_{L}⁽¹⁾(n) is multiplied by amplitude ratio g again, section 2 R-channel decoded signal Ŝ_{R}⁽²⁾(n) is obtained. By repeating the same kind of computation in this way, stereo speech decoding apparatus 200 can decode stereo speech.

That is to say, stereo speech decoding apparatus 200 first identifies, in monaural decoded signal Ŝ_{M}(n), not a section in which L-channel signal S_{L}(n) and R-channel signal S_{R}(n) are both present, but section 0 in which only L-channel signal S_{L}(n) is present. Next, stereo speech decoding apparatus 200 performs scale adjustment of identified section 0 L-channel signal S_{L}⁽⁰⁾(n) and predicts the next section 1 R-channel signal S_{R}⁽¹⁾(n). Then L-channel signal S_{L}⁽¹⁾(n) in section 1 is found by subtracting a contribution of predicted R-channel signal S_{R}⁽¹⁾(n) from section 1 monaural signal S_{M}⁽¹⁾(n) (a signal in which L-channel S_{L}⁽¹⁾(n) and R-channel S_{R}⁽¹⁾(n) are mixed). By successively repeating the above scale adjustment and separation processing, stereo speech decoding apparatus 200 obtains L-channel signal S_{L}(n) and R-channel signal S_{R}(n) in each section.

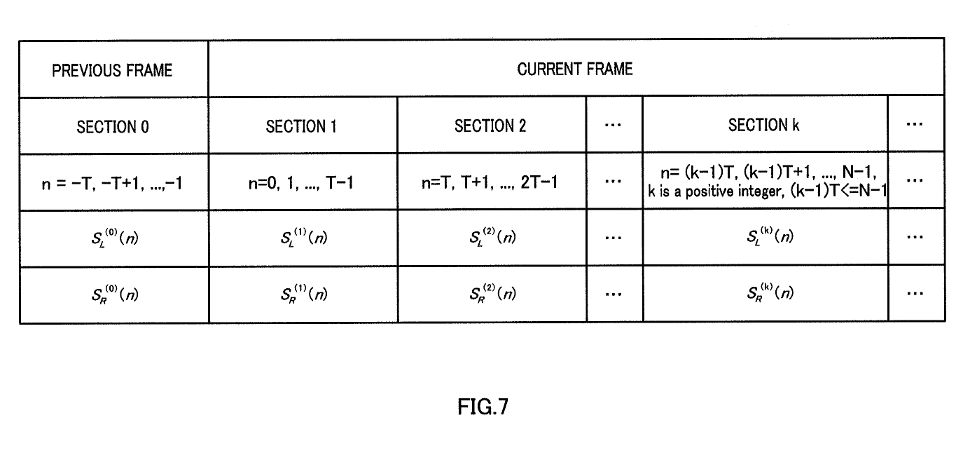

FIG. 7 is a drawing summarizing the stereo speech signals shown in FIG. 6 in a table. In this drawing, the first line shows the frame order and the second line shows section numbers. The third line shows the possible range of values of sample number n, and the fourth line and fifth line respectively show the L-channel signal and R-channel signal corresponding to the respective sections.

Next, the stereo speech signal decoding procedure in stereo speech decoding apparatus 200 will be described in detail.

First, monaural signal decoding section 201 decodes monaural signal encoding parameter P_{M} to obtain monaural decoded signal Ŝ_{M}(n).

Then onset position decoding section 202 decodes onset position encoding parameter P_{B} to obtain decoded onset position B̂.

Next, amplitude ratio decoding section 231 decodes amplitude ratio encoding parameter P_{g} to obtain decoded amplitude ratio ĝ, and delay time difference decoding section 232 decodes delay time difference encoding parameter P_{T} to obtain decoded delay time difference T̂.

Then preceding channel decoded signal separation section 233 obtains section 0 L-channel decoded signal Ŝ_{L}⁽⁰⁾(n) using decoded delay time difference T̂, monaural decoded signal Ŝ_{M}(n), and decoded onset position B̂. In section 0 only an L-channel signal is present, and therefore the monaural decoded signal is an L-channel decoded signal—that is, L-channel decoded signal Ŝ_{L}⁽⁰⁾(n) up to the onset position is obtained in accordance with above Equation (5).

Next, succeeding channel decoded signal generation section 234 obtains R-channel decoded signal Ŝ_{R}⁽¹⁾(n) in section 1 in accordance with above Equation (7).

Then, since monaural signal S_{M}(n) has been found in stereo speech encoding apparatus 100 as the average value of L-channel signal S_{L}(n) and R-channel signal S_{R}(n), preceding channel decoded signal separation section 233 obtains L-channel decoded signal Ŝ_{L}⁽¹⁾(n) in section 1 in accordance with Equation (8) below.

Ŝ_{L}⁽¹⁾(n)=2·Ŝ_{M}⁽¹⁾(n)−Ŝ_{R}⁽¹⁾(n)=2·Ŝ_{M}⁽¹⁾(n)−ĝ·Ŝ_{L}⁽⁰⁾(n−T) (Equation 8)

Here, n satisfies the condition 0≦n<T. Equation (7) is substituted in Equation (8). That is to say, Ŝ_{L}⁽⁰⁾(n−T) (where 0≦n<T) equivalent to a section 0 L-channel decoded signal found by preceding channel decoded signal separation section 233 is used in succeeding channel decoded signal generation section 234.

Next, preceding channel decoded signal separation section 233 and succeeding channel decoded signal generation section 234 recursively repeat for section 2 onward the computation shown in above Equation (7) and Equation (8) based on control by repeat computation control section 235, and obtain L-channel decoded signal Ŝ_{L}(n) and R-channel decoded signal Ŝ_{R}(n) in all sections.

Specifically, R-channel decoded signal Ŝ_{R}⁽²⁾(n) in section 2 is found in the same way by recursively repeating the computation shown in Equation (7) for section 2—that is, R-channel decoded signal Ŝ_{R}⁽²⁾(n) is found by scale adjustment of Ŝ_{L}⁽¹⁾(n−T) in accordance with Equation (9) below.

Ŝ_{R}⁽²⁾(n)=ĝ·Ŝ_{L}⁽¹⁾(n−T) (Equation 9)

In this equation, T≦n<2·T, and Ŝ_{L}⁽¹⁾(n−T) (where T≦n<2·T) equivalent to a section 1 L-channel decoded signal is used recursively for section 2.

Next, L-channel decoded signal Ŝ_{L}⁽²⁾(n) in section 2 is found by repeating the computation shown in Equation (8) for section 2—that is, in accordance with Equation (10) below.

Ŝ_{L}⁽²⁾(n)=2·Ŝ_{M}⁽²⁾(n)−Ŝ_{R}⁽²⁾(n)=2·Ŝ_{M}⁽²⁾(n)−ĝ·Ŝ_{L}⁽¹⁾(n−T) (Equation 10)

In this equation, T≦n<2·T, and Ŝ_{L}⁽¹⁾(n−T) (where T≦n<2·T) equivalent to a section 1 L-channel decoded signal is used recursively for section 2.

L-channel decoded signal Ŝ_{L}^{(j+1)}(n) and R-channel decoded signal Ŝ_{R}^{(j+1)}(n) in section j+1 are found, in the same way as with the method of finding L-channel decoded signal Ŝ_{L}⁽²⁾(n) and R-channel decoded signal Ŝ_{R}⁽²⁾(n) in section 2, by using the computation results for section j recursively. Specifically, R-channel decoded signal Ŝ_{R}^{(j+1)}(n) in section j+1 is obtained in accordance with Equation (11) below.

Ŝ_{R}^{(j+}1)(n)=ĝ·Ŝ_{L}^{(j)}(n−T) (Equation 11)

In this equation, j·T≦n<(j+1)·T, j=0, . . . , J−1, J·T≦n<N, where J is an integer value satisfying the condition J·T≦n<(J+1)·T.

Then L-channel decoded signal Ŝ_{L}^{(j+1)}(n) in section j+1 is found in accordance with Equation (12) below.

Ŝ_{L}^{(j+1)}(n)=2·Ŝ_{M}^{(j+1)}(n)−Ŝ_{R}^{(j+1)}(n)=2·Ŝ_{M}^{(j+1)}(n)−ĝ·Ŝ_{L}^{(j)}(n−T) (Equation 12)

Here, j·T≦n<(j+1)·T j=0, . . . , J−1
j·T≦n<N j=J
j=0, . . . , J and J is an integer value satisfying the condition J·T≦N<(J+1)·T.

If j=j−1 is set in above Equation (12), Equation (13) below is obtained.

Ŝ_{L}^{(j)}(n)=2·Ŝ_{M}^{(j)}(n)−ĝ·Ŝ_{L}^{(j-1)}(n−T) (Equation 13)

If the result of Equation (13) when making n=n−T is substituted in the second term on the right side of Equation (12), Equation (14) below is obtained.

Ŝ_{L}^{(j+1)}(n)=2·Ŝ_{M}^{(j+1)}(n)−ĝ·{2·Ŝ_{M}^{(j)}(n−T)−ĝ·Ŝ_{L}^{(j-1)}(n−2·T)} (Equation 14)

If j=j−1 is set in Equation (13), Equation (15) below is obtained.

Ŝ_{L}^{(j-1)}(n)=2·Ŝ_{M}^{(j-1)}(n)−ĝ·Ŝ_{L}^{(j-2)}(n−T) (Equation 15)

Furthermore, if the result of Equation (15) when making n=n−2·T is substituted in the third term on the right side of Equation (14), Equation (16) below is obtained.

Ŝ_{L}^{(j+1)}(n)=2·Ŝ_{M}^{(j+1)}(n)−2·ĝ·Ŝ_{M}^{(j)}(n−T)−ĝ·(−ĝ){2·Ŝ_{M}^{(j-1)}(n−2·T)−ĝ·Ŝ_{L}^{(j-2)}(n−3·T)} (Equation 16)

If the computations in Equations (13) through (16) are repeated, Equation (17) below is obtained.

$$\begin{matrix}( Equation 17 ) & \\ \begin{matrix}{{S}_{L}^{\hat{}}}^{( j + 1 )} ( n ) = {\sum }_{i = 0}^{j} 2 \cdot {( - 1 )}^{i} \cdot {( {g}^{\hat{}} )}^{i} \cdot {S}_{M}^{\hat{}} ( n - i \cdot T ) + \\ {( - 1 )}^{( j + 1 )} \cdot {( {g}^{\hat{}} )}^{( j + 1 )} \cdot {S}_{L}^{\hat{}} ( n - ( j + 1 ) \cdot T ) \\ = {\sum }_{i = 0}^{j} 2 \cdot {( - 1 )}^{i} \cdot {( {g}^{\hat{}} )}^{i} \cdot {S}_{M}^{\hat{}} ( n - i \cdot T ) + \\ {( - 1 )}^{( j + 1 )} \cdot {( {g}^{\hat{}} )}^{( j + 1 )} \cdot {S}_{M}^{\hat{}} ( n - ( j + 1 ) \cdot T )\end{matrix} \\ where , \begin{matrix}j \cdot T \leq n < ( j + 1 ) T & j = 0 , … , J - 1 \\ j \cdot T \leq n < N & j = J \\ j = 0 , … , J & \end{matrix} & [ 4 ]\end{matrix}$$

and J is an integer value satisfying the condition
J·T≦N<(J+1)·T.
Ŝ_{M}(n): monaural decoded signal
Ŝ_{L}(n): L-channel decoded signal

In this equation, Ŝ_{M}(n−(j+1)·T) on the right side is actually a section 0 monaural signal.

That is to say, preceding channel decoded signal separation section 233 may also find L-channel decoded signal Ŝ_{L}^{(j+1)}(n) using only monaural decoded signal Ŝ_{M}(n) in accordance with above Equation (17). In this case, R-channel decoded signal Ŝ_{R}^{(j+1)}(n) may be found by performing scale adjustment of L-channel decoded signal Ŝ_{L}^{(j+1)}(n).

Thus, according to this embodiment, a stereo speech encoding apparatus, instead of encoding a monaural signal and prediction information of L-channel signal and R-channel signal for all sections, encodes a monaural signal, onset position, delay time difference, and amplitude ratio, and transmits these to a stereo speech decoding apparatus. The stereo speech decoding apparatus decodes a stereo speech signal by performing repeated computations using encoded information transmitted from the stereo speech encoding apparatus. Since the amount of onset position, delay time difference, and amplitude ratio information is smaller than the amount of L-channel signal and R-channel signal prediction information for all sections, this embodiment enables the number of prediction coefficients to be reduced, and stereo speech signal transmission to be performed at a lower bit rate.

In this embodiment, a case has been described by way of example in which a stereo speech signal is composed of two channels comprising an L-channel signal and R-channel signal, and the L-channel signal is nearer to the source than the R-channel signal, but this embodiment can also be applied to a case in which the R-channel signal is nearer to the source than the L-channel signal, in which case an L-channel signal is not present and only an R-channel signal is present in section 0 from the speech onset position to initial delay time difference T. Furthermore, this embodiment, modified as appropriate, can also be applied to a case in which a stereo speech signal is composed of three or more channel signals.

In this embodiment, a case has been described by way of example in which decoding is performed by a stereo decoding apparatus by scale-adjusting a section 0 L-channel signal to give a section 1 R-channel signal, but a model waveform may also be stored beforehand and used as a section 1 R-channel signal (or L-channel signal).

In this embodiment, a case has been described by way of example in which a CELP encoding method is used as a monaural signal encoding method, but an encoding method other than a CELP encoding method may also be used.

In this embodiment, a method whereby an average value of an L-channel signal and R-channel signal is calculated has been described as a monaural signal generation method by way of example, but a different method may also be used as a monaural signal generation method, one example of which can be expressed by the equation S_{M}(n)=w₁S_{L}(n)+w₂S_{R}(n). In this equation, w₁ and w₂ are weighting coefficients that satisfy the relationship w₁+w₂=1.0.

In this embodiment, a case has been described by way of example in which a stereo speech signal is encoded and transmitted, but a stereo audio signal composed of an inactive speech section and active speech section may also be encoded and transmitted.

### Embodiment 2

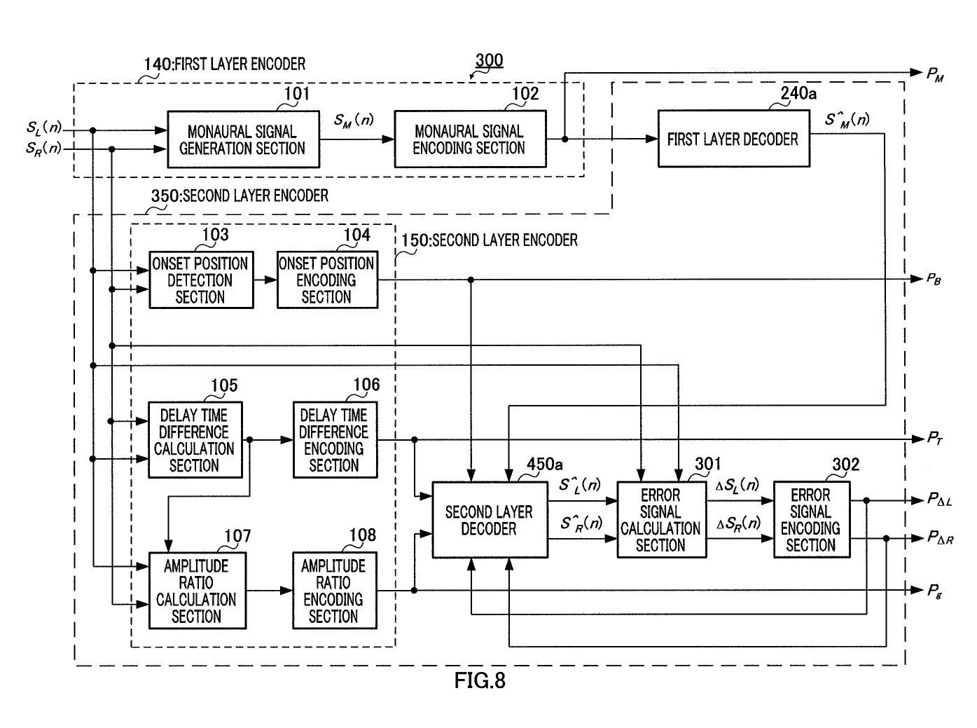

FIG. 8 is a block diagram showing the main configuration of stereo speech encoding apparatus 300 according to Embodiment 2 of the present invention. Stereo speech encoding apparatus 300 has the same kind of basic configuration as stereo speech encoding apparatus 100 shown in Embodiment 1 (see FIG. 1), and therefore identical configuration elements are assigned the same reference codes and descriptions thereof are omitted. Stereo speech encoding apparatus 300 differs from stereo speech encoding apparatus 100 shown in Embodiment 1 in being further provided with first layer decoder 240a, second layer decoder 450a, error signal calculation section 301, and error signal encoding section 302. In stereo speech encoding apparatus 300, first layer decoder 240a, second layer decoder 450a, error signal calculation section 301, error signal encoding section 302, and second layer encoder 150 compose second layer encoder 350.

In stereo speech encoding apparatus 300, first layer decoder 240a functioning as a local decoder has the same kind of configuration and function as first layer decoder 240 with which stereo speech decoding apparatus 200 according to Embodiment 1 is provided. That is to say, first layer decoder 240a has monaural signal encoding parameter P_{M} generated by monaural signal encoding section 102 as input, decodes a monaural signal, and outputs obtained monaural decoded signal Ŝ_{M}(n) to second layer decoder 450a.

Second layer decoder 450a functioning as a separate local decoder of stereo speech encoding apparatus 300 performs stereo speech signal decoding using monaural decoded signal Ŝ_{M}(n) generated by first layer decoder 240a, onset position encoding parameter P_{B} generated by onset position encoding section 104, delay time difference encoding parameter P_{T} generated by delay time difference encoding section 106, amplitude ratio encoding parameter P_{g} generated by amplitude ratio encoding section 108, and L-channel error signal encoding parameter P_{ΔL} and R-channel error signal encoding parameter P_{ΔR} generated by error signal encoding section 302. Second layer decoder 450a outputs L-channel decoded signal Ŝ_{L}(n) and R-channel decoded signal Ŝ_{R}(n) to error signal calculation section 301. The configuration of second layer decoder 450a will be described in detail later herein.

Using stereo speech encoding apparatus 300 input signals L-channel signal S_{L}(n) and R-channel signal S_{R}(n), and L-channel decoded signal Ŝ_{L}(n) and R-channel decoded signal Ŝ_{R}(n) generated by second layer decoder 450a, error signal calculation section 301 calculates L-channel error signal ΔS_{L}(n) and R-channel error signal ΔS_{R}(n) in accordance with Equation (18) and Equation (19) below.

ΔS_{L}(n)=S_{L}(n)−Ŝ_{L}(n) (Equation 18)

ΔS_{R}(n)=S_{R}(n)−Ŝ_{R}(n) (Equation 19)

Error signal calculation section 301 outputs calculated L-channel error signal ΔS_{L}(n) and R-channel error signal ΔS_{R}(n) to error signal encoding section 302.

Error signal encoding section 302 encodes L-channel error signal ΔS_{L}(n) and R-channel error signal ΔS_{R}(n) calculated by error signal calculation section 301, and transmits L-channel error signal encoding parameter P_{ΔL} and R-channel error signal encoding parameter P_{ΔR} to stereo speech decoding apparatus 400.

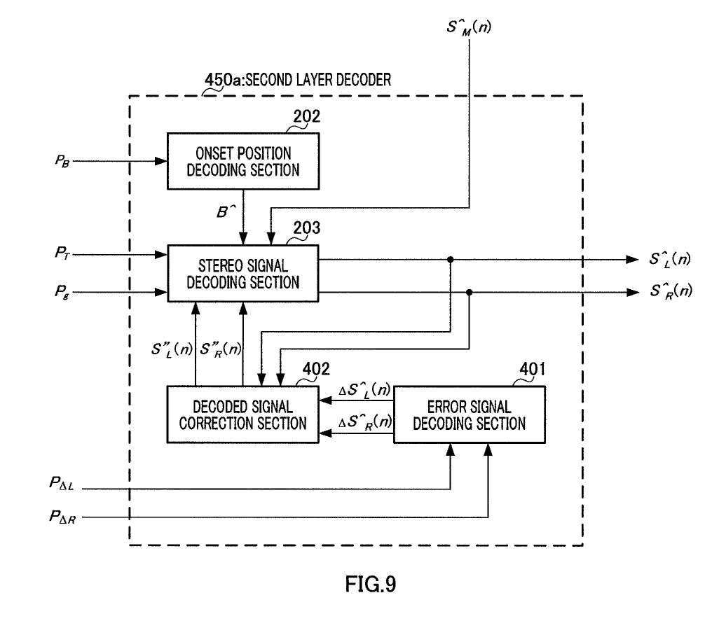

FIG. 9 is a block diagram showing the detailed configuration of second layer decoder 450a according to Embodiment 2 of the present invention. Second layer decoder 450a has the same kind of basic configuration as second layer decoder 250 shown in Embodiment 1 (see FIG. 4), and therefore identical configuration elements are assigned the same reference codes and descriptions thereof are omitted. Second layer decoder 450a differs from second layer decoder 250 shown in Embodiment 1 in being further provided with error signal decoding section 401 and decoded signal correction section 402.

Error signal decoding section 401 decodes L-channel error signal encoding parameter P_{ΔL} and R-channel error signal encoding parameter P_{ΔR} input from error signal encoding section 302, and outputs generated L-channel error decoded signal ΔŜ_{L}(n) and R-channel error decoded signal ΔŜ_{R}(n) to decoded signal correction section 402.

Using L-channel error decoded signal ΔŜ_{L}(n) and R-channel error decoded signal ΔŜ_{R}(n) generated by error signal decoding section 401 and L-channel decoded signal Ŝ_{L}(n) and R-channel decoded signal Ŝ_{R}(n) generated by stereo signal decoding section 203, decoded signal correction section 402 generates error-corrected L-channel decoded signal S″_{L}(n) and R-channel decoded signal S″_{R}(n) in accordance with Equation (20) and Equation (21) below, and outputs these signals to stereo signal decoding section 203.

S″_{L}(n)=Ŝ_{L}(n)+ΔŜ_{L}(n) (Equation 20)

S″_{R}(n)=Ŝ_{R}(n)+ΔŜ_{R}(n) (Equation 21)

Error-corrected L-channel decoded signal S″_{L}(n) and R-channel decoded signal S″_{R}(n) are used for decoding of a stereo speech signal in the next section by stereo signal decoding section 203, and L-channel decoded signal Ŝ_{L}(n) and R-channel decoded signal Ŝ_{R}(n) with less error than in Embodiment 1 are obtained.

As described above, encoding parameters transmitted to stereo speech decoding apparatus 400 by stereo speech encoding apparatus 300 are monaural signal encoding parameter P_{M}, onset position encoding parameter P_{B}, delay time difference encoding parameter P_{T}, amplitude ratio encoding parameter P_{g}, L-channel error signal encoding parameter P_{ΔL}, and R-channel error signal encoding parameter P_{ΔR}.

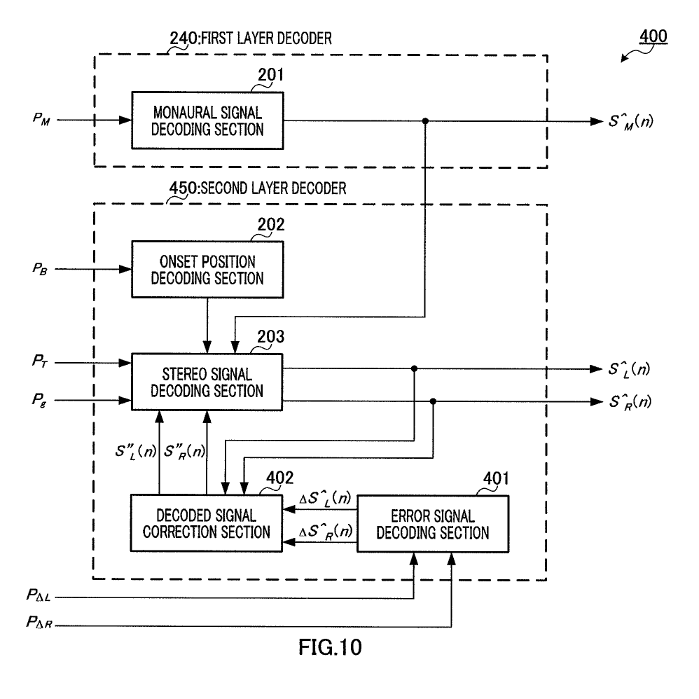

FIG. 10 is a block diagram showing the main configuration of stereo speech decoding apparatus 400 according to this embodiment.

In FIG. 10, stereo speech decoding apparatus 400 is provided with first layer decoder 240 and second layer decoder 450. First layer decoder 240 of stereo speech decoding apparatus 400 has the same configuration and function as first layer decoder 240 shown in FIG. 4, and therefore a description thereof is omitted here. Second layer decoder 450 of stereo speech decoding apparatus 400 has the same kind of configuration and function as second layer decoder 450a shown in FIG. 9. That is to say, second layer decoder 450 has onset position encoding parameter P_{B}, delay time difference encoding parameter P_{T}, amplitude ratio encoding parameter P_{g}, L-channel error signal encoding parameter P_{ΔL}, and R-channel error signal encoding parameter P_{ΔR} transmitted from stereo speech encoding apparatus 300 as input, performs stereo signal decoding, and outputs L-channel decoded signal Ŝ_{L}(n) and R-channel decoded signal Ŝ_{R}(n).

Thus, according to this embodiment, as compared with Embodiment 1 a stereo speech encoding apparatus further transmits L-channel error signal encoding parameter P_{ΔL} and R-channel error signal encoding parameter P_{ΔR}, and the stereo speech encoding apparatus can generate and output L-channel decoded signal Ŝ_{L}(n) and R-channel decoded signal Ŝ_{R}(n) with less error.

In this embodiment, a case has been described by way of example in which onset position encoded information is found by a stereo encoding apparatus and transmitted to a stereo decoding apparatus, but it is also possible for a stereo encoding apparatus not to be provided with an onset position detection section or onset position encoding section, and a stereo decoding apparatus not to be provided with an onset position decoding section, and for an onset position to be detected and decoding performed by means of processing by an error signal correction section and stereo signal decoding section on the stereo decoding apparatus side.

In this embodiment, a case has been described by way of example in which error signals of both an L-channel signal and R-channel signal are encoded, but encoding of only an error signal of the preceding channel signal—in this embodiment, the L-channel signal—may also be performed. However, the quality of a stereo speech signal decoded by a stereo speech decoding apparatus can be improved to a greater extent by encoding error signals of both the L-channel signal and R-channel signal than by encoding only an error signal of the preceding channel signal.

In this embodiment, a case has been described by way of example in which an L-channel decoded signal and R-channel decoded signal output from a stereo speech decoding apparatus are not fed back to a stereo signal decoding section, but an L-channel decoded signal and R-channel decoded signal output from a stereo speech decoding apparatus may also be fed back to a stereo signal decoding section in delay time difference units, in which case a stereo speech decoding apparatus can obtain and output an L-channel decoded signal and R-channel decoded signal with still less error.

### Embodiment 3

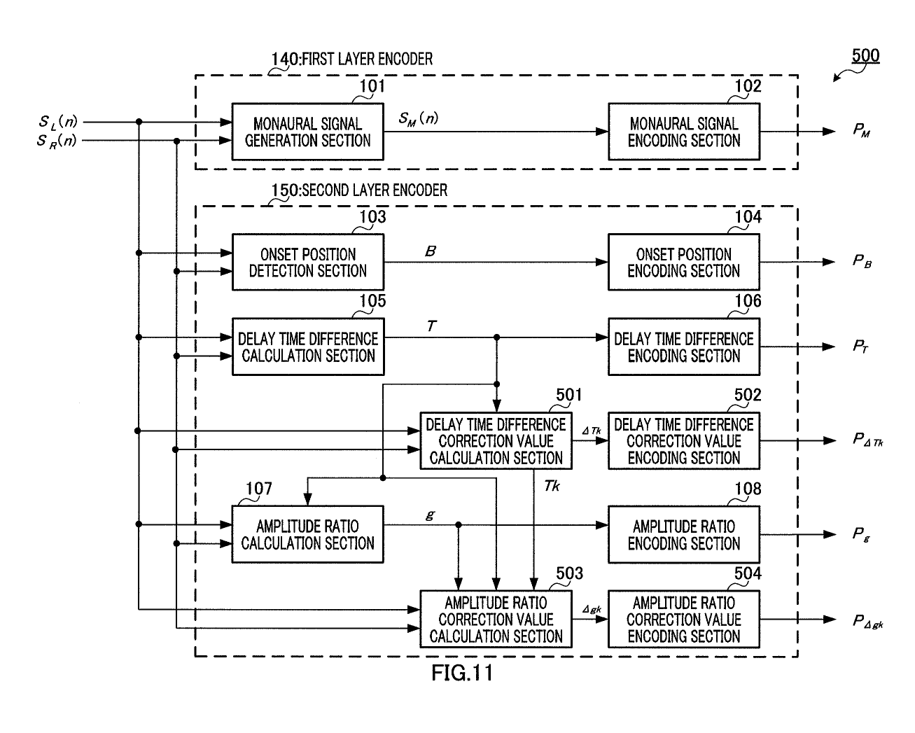

FIG. 11 is a block diagram showing the main configuration of stereo speech encoding apparatus 500 according to Embodiment 3 of the present invention. Stereo speech encoding apparatus 500 has the same kind of basic configuration as stereo speech encoding apparatus 100 shown in Embodiment 1 (see FIG. 1), and therefore identical configuration elements are assigned the same reference codes and descriptions thereof are omitted. Stereo speech encoding apparatus 500 differs from stereo speech encoding apparatus 100 shown in Embodiment 1 in being further provided with delay time difference correction value calculation section 501, delay time difference correction value encoding section 502, amplitude ratio correction value calculation section 503, and amplitude ratio correction value encoding section 504.

Delay time difference correction value calculation section 501 divides L-channel signal S_{L}(n) and R-channel signal S_{R}(n) into K sections of a length corresponding to delay time difference T input from delay time difference calculation section 105, and calculates fluctuation amount ΔTₖ of delay time difference Tₖ between L-channel signal S_{L}(kT+n) and R-channel signal S_{R}(kT+n) with respect to delay time difference T in each section—that is, delay time difference correction value ΔTₖ in section k (where k indicates the section number, and k=0, 1, 2, . . . K). Specifically, delay time difference correction value calculation section 501 first calculates a cross-correlation function for L-channel signal S_{L}(kT+n) and R-channel signal S_{R}(kT+n) in section k using Equation (22) below.

$$\begin{matrix}( Equation 22 ) & \\ {φ}_{k} ( {τ}_{k} ) = {\sum }_{n = 0}^{T - 1} {S}_{L} ( kT + n - {τ}_{k} ) \cdot {S}_{R} ( kT + n ) & [ 5 ]\end{matrix}$$

In this equation, T indicates the number of samples contained in each section, and τₖ indicates the number of R-channel signal S_{R}(n) shift samples with respect to L-channel signal S_{L}(n). Also, φₖ(τₖ) indicates a cross-correlation value of L-channel signal S_{L}(kT+n) and R-channel signal S_{R}(kT+n) in section k, and delay time difference calculation section 105 calculates the value of τₖ for which the value of φₖ(τₖ) is maximum as delay time difference Tₖ between L-channel signal S_{L}(kT+n) and R-channel signal S_{R}(kT+n) in section k. Thus, while delay time difference T indicates the delay time difference between an L-channel signal and R-channel signal in one frame overall, delay time difference Tₖ indicates the delay time difference between an L-channel signal and R-channel signal in each section within one frame. Then, using Equation (23) below, delay time difference correction value calculation section 501 calculates the fluctuation amount of delay time difference Tₖ in section k with respect to delay time difference T as delay time difference correction value ΔTₖ in section k.

ΔTₖ=Tₖ−T (Equation 23)

Delay time difference correction value calculation section 501 outputs calculated delay time difference correction value ΔTₖ to delay time difference correction value encoding section 502, and outputs delay time difference Tₖ in section k to amplitude ratio correction value calculation section 503.

Delay time difference correction value encoding section 502 encodes delay time difference correction value ΔTₖ input from delay time difference correction value calculation section 501, and transmits generated delay time difference correction value encoding parameter P_{ΔTk} to a stereo speech decoding apparatus according to this embodiment (not shown).

Amplitude ratio correction value calculation section 503 divides L-channel signal S_{L}(n) and R-channel signal S_{R}(n) into K sections with delay time difference T input from delay time difference calculation section 105 as the length, and calculates fluctuation amount Δgₖ of amplitude ratio gₖ between L-channel signal S_{L}(kT+n−ΔTₖ) and R-channel signal S_{R}(kT+n) with respect to amplitude ratio g in each section—that is, amplitude ratio correction value Δgₖ in section k—using delay time difference Tₖ input from delay time difference correction value calculation section 501 and amplitude ratio g input from amplitude ratio calculation section 107. Specifically, amplitude ratio correction value calculation section 503 first calculates amplitude ratio gₖ between R-channel signal S_{R}(kT+n) and L-channel signal S_{L}(kT+n) in section k taking account of delay time difference Tₖ in accordance with Equation (24) below.

$$\begin{matrix}( Equation 24 ) & \\ {g}_{k} = \frac{{A}_{R} ( k )}{{A}_{L} ( k )} = \sqrt{\frac{{\sum }_{n = 0}^{T - 1} {{S}_{R} ( kT + n )}^{2}}{{\sum }_{n = 0}^{T - 1} {{S}_{L} ( kT + n - {T}_{k} )}^{2}}} & [ 6 ]\end{matrix}$$

Thus, while amplitude ratio g indicates the amplitude ratio between an L-channel signal and R-channel signal in one frame overall, amplitude ratio gₖ indicates the amplitude ratio between an L-channel signal and R-channel signal in each section within one frame. Then, using Equation (25) below, amplitude ratio correction value calculation section 503 calculates the fluctuation amount of amplitude ratio gₖ in section k with respect to amplitude ratio g as amplitude ratio correction value Δgₖ in section k.

Δgₖ=gₖ/g (Equation 25)

That is to say, amplitude ratio correction value calculation section 503 calculates the ratio between amplitude ratio gₖ between R-channel signal S_{R}(kT+n) and L-channel signal S_{L}(kT+n) in section k and amplitude ratio g input from amplitude ratio calculation section 107 as amplitude ratio correction value Δgₖ. Amplitude ratio correction value calculation section 503 outputs calculated amplitude ratio correction value Δgₖ to amplitude ratio correction value encoding section 504.

Amplitude ratio correction value encoding section 504 encodes amplitude ratio correction value Δgₖ input from amplitude ratio correction value calculation section 503, and transmits generated amplitude ratio correction value encoding parameter P_{Δgk} to a stereo speech decoding apparatus according to this embodiment.

A stereo speech decoding apparatus according to this embodiment has the same kind of basic configuration and function as stereo speech decoding apparatus 200 according to Embodiment 1 of the present invention, but differs from stereo speech decoding apparatus 200 in further using delay time difference correction value ΔTₖ and amplitude ratio correction value Δgₖ in decoding stereo speech. For example, in delay time difference decoding section 232, delay time difference correction value encoding parameter P_{ΔTk} is decoded, and delay time difference T is corrected using obtained delay time difference correction value ΔTₖ. Also, in amplitude ratio decoding section 231, amplitude ratio correction value encoding parameter P_{Δgk} is decoded, and amplitude ratio g is corrected using amplitude ratio correction value Δgₖ. A stereo speech decoding apparatus according to this embodiment is not shown in a drawing here, and a more detailed description will be omitted.

Thus, according to this embodiment, a stereo speech encoding apparatus divides a one-frame stereo speech signal into a plurality of sections of a length corresponding to delay time difference T, and transmits fluctuation amounts of delay time difference Tₖ and amplitude ratio gₖ in each section with respect to delay time difference T and amplitude ratio g in one frame overall as delay time difference correction value ΔTₖ and amplitude ratio correction value Δgₖ, enabling stereo speech encoding prediction error to be further reduced. As delay time difference correction value ΔTₖ and amplitude ratio correction value Δgₖ are smaller values than delay time difference Tₖ and amplitude ratio gₖ in section k, a stereo speech signal can be encoded at a lower bit rate.

In this embodiment, a case has been described by way of example in which delay time difference correction value calculation section 501 calculates a cross-correlation value with section k whose length is delay time difference T as a computation range, as shown in Equation (22), but this embodiment is not limited to this case, and delay time difference correction value calculation section 501 may also calculate a cross-correlation value with a section of range (T-Δa) to (T-Δb) including section k as a computation range.

In this embodiment, a case has been described by way of example in which delay time difference correction value encoding section 502 encodes delay time difference correction value ΔTₖ in each section individually, and generates K delay time difference correction value encoding parameters P_{ΔTk}, but delay time difference correction value encoding section 502 may also encode K delay time difference correction values ΔTₖ collectively, and generate one delay time difference correction value encoding parameter (designated P_{ΔT}, for example).

In this embodiment, a case has been described by way of example in which amplitude ratio correction value encoding section 504 encodes amplitude ratio correction value Δgₖ in each section individually, and generates K amplitude ratio correction value encoding parameters P_{Δgk}, but delay time difference correction value encoding section 502 may also encode K amplitude ratio correction values Δgₖ collectively, and generate one amplitude ratio correction value encoding parameter (designated P_{Δg}, for example).

### Embodiment 4

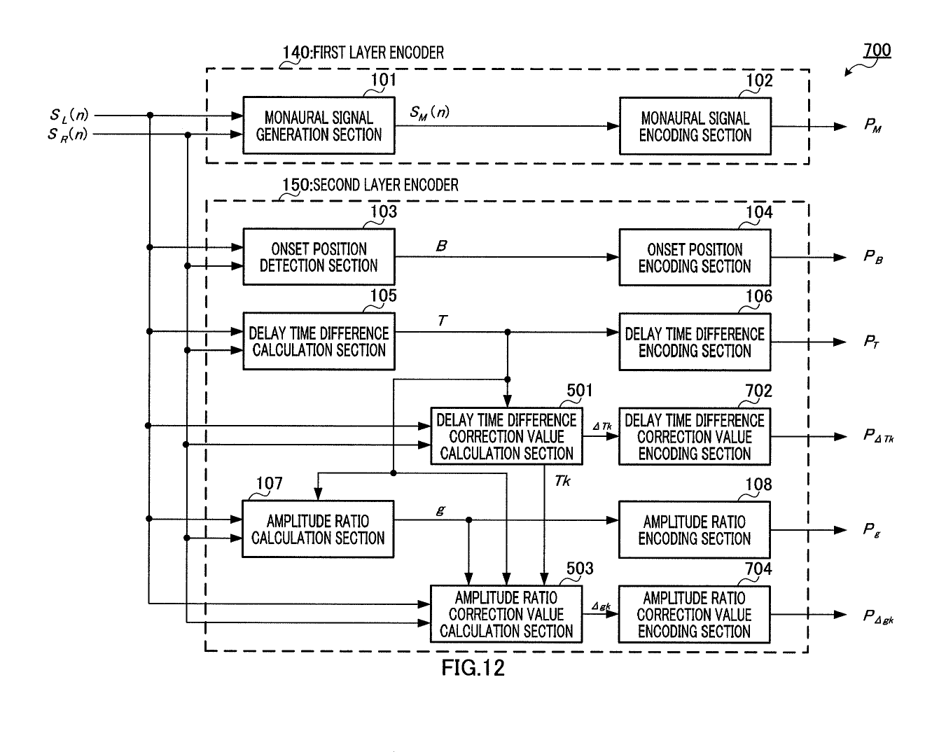

FIG. 12 is a block diagram showing the main configuration of stereo speech encoding apparatus 700 according to this embodiment. Stereo speech encoding apparatus 700 has the same kind of basic configuration as stereo speech encoding apparatus 500 shown in Embodiment 3 of the present invention (see FIG. 11), and therefore identical configuration elements are assigned the same reference codes and descriptions thereof are omitted. There is some difference in processing between delay time difference correction value encoding section 702 and amplitude ratio correction value encoding section 704 of stereo speech encoding apparatus 700, and delay time difference correction value encoding section 502 and amplitude ratio correction value encoding section 504 of stereo speech encoding apparatus 500, and different reference codes are assigned to indicate this.

Delay time difference correction value encoding section 702 differs from delay time difference correction value encoding section 502 in further incorporating a first encoding bit table, and encoding a delay time difference correction value input from delay time difference correction value calculation section 501 using this internal first encoding bit table. The first encoding bit table is provided with a number of encoding bits of each section for encoding delay time difference correction value ΔTₖ (where 1≦k≦K) in each section input from delay time difference correction value calculation section 501. If the total number of bits for encoding all delay time difference correction values ΔTₖ in one frame is indicated by M, and the number of bits for encoding delay time difference correction value ΔTₖ in each section k is indicated by TB(k), Equation (26) and Equation (27) below are satisfied.

$$\begin{matrix}( Equation 26 ) & \\ TB ( k ) ≧ TB ( k - 1 ) & [ 7 ] \\ ( Equation 27 ) & \\ M = {\sum }_{k = 0}^{K - 1} TB ( k ) & \end{matrix}$$

When quantization is performed on delay time difference correction value ΔTₖ in each section k, for example, TB(k) indicates the number of scalar quantization bits. As shown in Equation (26) and Equation (27), delay time difference correction value encoding section 702 allocates more encoding bits to encoding of delay time difference correction value ΔTₖ in a section near the end of a frame—that is, a section for which section number k is larger, than a section near the start of a frame.

Amplitude ratio correction value encoding section 704 differs from amplitude ratio correction value encoding section 504 in further incorporating a second encoding bit table, and encoding an amplitude ratio correction value input from amplitude ratio correction value calculation section 503 using this internal second encoding bit table. The second encoding bit table is provided with a number of encoding bits of each section for encoding amplitude ratio correction value Δgₖ (where 1≦k≦K) in each section input from amplitude ratio correction value calculation section 503. If the total number of bits for encoding all amplitude ratio correction values Δgₖ in one frame is indicated by N, and the number of bits for encoding amplitude ratio correction value Δgₖ in each section k is indicated by AB(k), Equation (28) and Equation (29) below are satisfied.

$$\begin{matrix}( Equation 28 ) & \\ AB ( k ) ≧ AB ( k - 1 ) & [ 8 ] \\ ( Equation 29 ) & \\ N = {\sum }_{k = 0}^{K - 1} AB ( k ) & \end{matrix}$$

When quantization is performed on amplitude ratio correction value Δgₖ in each section k, for example, AB(k) indicates the number of scalar quantization bits. As shown in Equation (28) and Equation (29), amplitude ratio correction value encoding section 704 allocates more encoding bits to encoding of amplitude ratio correction value Δgₖ in a section near the end of a frame—that is, a section for which section number k is larger, than a section near the start of a frame.

Stereo speech decoding apparatus 800 according to this embodiment (not shown) finds a stereo speech decoded signal in accordance with Equation (17), and corrects stereo speech decoded signal error using delay time difference correction value ΔTₖ and amplitude ratio correction value Δgₖ. Since stereo speech decoding apparatus 800 uses delay time difference T and amplitude ratio g recursively to calculate a stereo speech decoded signal of each section in one frame as shown in Equation (17), with increase of section number k, calculated stereo speech decoded signal error increases. The reason is that, with increase of section number k, and delay time difference correction value ΔTₖ and amplitude ratio correction value Δgₖ increase. Therefore, if the number of encoding bits of delay time difference correction value ΔTₖ and amplitude ratio correction value Δgₖ is increased as section number k increases, prediction error can be reduced, and speech quality of stereo speech decoded signal can be improved.

Thus, according to this embodiment, a stereo speech encoding apparatus allocates more encoding bits to encoding of an amplitude ratio correction value and delay time difference correction value in a section near the end of a frame than a section near the start of a frame, enabling prediction error to be reduced, and speech quality of stereo speech decoded signal to be improved.

In this embodiment, a case has been described by way of example in which the number of encoding bits is increased the nearer a section in a frame is to the end of the frame, but this embodiment is not limited to this case, and it is also possible to divide all K sections in one frame into a plurality of blocks, and increase the number of encoding bits the nearer a block is to the end of the frame. That is to say, the same number of encoding bits is used for encoding of delay time difference correction value or amplitude ratio correction value in each section in the same block.

An effect of reducing prediction error can also be obtained by applying an encoding bit allocation method according to this embodiment to Embodiment 2 of the present invention. For example, when error signal encoding section 302 quantizes an L-channel error signal and R-channel signal error input from error signal calculation section 301 in stereo speech encoding apparatus 300, quantization may be performed using more bits near the end of a frame than near the start of a frame.

This completes a description of embodiments of the present invention.

A stereo speech encoding apparatus, stereo speech decoding apparatus, and method thereof according to the present invention are not limited to the above-described embodiments, and various variations and modifications may be possible without departing from the scope of the present invention.

A stereo speech encoding apparatus and stereo speech decoding apparatus according to the present invention can be installed in a communication terminal apparatus and base station apparatus in a mobile communication system, thereby enabling a communication terminal apparatus and base station apparatus having the same kind of operational effects as described above to be provided. It is also possible for a stereo speech encoding apparatus, stereo speech decoding apparatus, and method thereof according to the present invention to be used in a cable communication system.

In this specification, a configuration has been described by way of example in which the present invention is applied to monaural-stereo scalable encoding, but a configuration may also be used whereby the present invention is applied to encoding/decoding on a band-by-band basis when band split encoding is performed on a stereo signal.

A configuration may also be used in which both a stereo signal encoding section according to the present invention and an ordinary stereo signal encoding section are included, and a mode switching section switches the stereo signal encoding section that is actually used based on the degree of correlation between an L-channel signal and R-channel signal. In this case, when the degree of correlation between the L-channel signal and R-channel signal is less than or equal to a threshold, the L-channel signal and R-channel signal are encoded separately using the ordinary stereo signal encoding section, and when the degree of correlation between the L-channel signal and R-channel signal is higher than the threshold, encoding of the L-channel signal and R-channel signal is performed using the stereo signal encoding section according to the present invention.

A case has here been described by way of example in which the present invention is configured as hardware, but it is also possible for the present invention to be implemented by software. For example, the same kind of functions as those of a stereo speech encoding apparatus of the present invention can be realized by writing an algorithm of the processing of a stereo speech coding method according to the present invention in a programming language, storing this program in memory, and having it executed by an information processing means.

The function blocks used in the descriptions of the above embodiments are typically implemented as LSIs, which are integrated circuits. These may be implemented individually as single chips, or a single chip may incorporate some or all of them.

Here, the term LSI has been used, but the terms IC, system LSI, super LSI, ultra LSI, and so forth may also be used according to differences in the degree of integration.

The method of implementing integrated circuitry is not limited to LSI, and implementation by means of dedicated circuitry or a general-purpose processor may also be used. An FPGA (Field Programmable Gate Array) for which programming is possible after LSI fabrication, or a reconfigurable processor allowing reconfiguration of circuit cell connections and settings within an LSI, may also be used.

In the event of the introduction of an integrated circuit implementation technology whereby LSI is replaced by a different technology as an advance in, or derivation from, semiconductor technology, integration of the function blocks may of course be performed using that technology. The application of biotechnology or the like is also a possibility.

The disclosures of Japanese Patent Application No.2006-99913, filed on Mar. 31, 2006, and Japanese Patent Application No.2006-272132, filed on Oct. 3, 2006, including the specifications, drawings and abstracts, are incorporated herein by reference in their entirety.

### INDUSTRIAL APPLICABILITY

A stereo speech encoding apparatus, stereo speech decoding apparatus, and method thereof according to the present invention are suitable for use in a communication terminal apparatus in a mobile communication system or the like.

1. A stereo speech decoding apparatus comprising:
a monaural signal decoding section that decodes encoded information in which a monaural signal in which a temporally-preceding preceding channel signal and a temporally-succeeding succeeding channel signal of a stereo speech signal composed of two channels are combined is encoded;
an onset position decoding section that decodes encoded information in which an onset position at which a change is made from an inactive speech section to an active speech section of said stereo speech signal is encoded;
a delay time difference decoding section that decodes encoded information in which a delay time difference between said preceding channel signal and succeeding channel signal is encoded;
an amplitude ratio decoding section that decodes encoded information in which an amplitude ratio between said succeeding channel signal and said preceding channel signal is encoded;
a preceding channel signal decoding section that decodes said preceding channel signal using said monaural signal, said delay time difference, and said onset position; and
a succeeding channel signal decoding section that decodes said succeeding channel signal using said preceding channel signal and said amplitude ratio.

2. The stereo speech decoding apparatus according to claim 1, wherein said monaural signal in a first section equivalent to said delay time difference from said onset position in which only said preceding channel signal is present is taken as said preceding channel signal of said first section.

3. The stereo speech decoding apparatus according to claim 2, wherein said succeeding channel signal decoding section takes a signal obtained by multiplying said preceding channel signal of said first section by said amplitude ratio as said succeeding channel signal of a second section continuing for said delay time difference after said first section.

4. The stereo speech decoding apparatus according to claim 3, wherein said preceding channel signal decoding section takes a signal obtained by subtracting a contribution of said succeeding channel signal of said second section from said monaural signal of said second section as said preceding channel signal of said second section.

5. The stereo speech decoding apparatus according to claim 1, wherein said monaural signal is an average value of said preceding channel signal and said succeeding channel signal.

6. The stereo speech decoding apparatus according to claim 1, wherein said delay time difference is set so that a cross-correlation function of said preceding channel signal and said succeeding channel signal is maximum.

7. The stereo speech decoding apparatus according to claim 1, wherein said amplitude ratio is a ratio between an average amplitude of said preceding channel signal in a predetermined section and an average amplitude of said preceding channel signal.

8. The stereo speech decoding apparatus according to claim 1, further comprising:
an error signal decoding section that decodes encoded information in which an error signal of said preceding channel signal decoding section and said succeeding channel signal decoding section is encoded; and
an error correction section that performs error correction of said preceding channel signal and said succeeding channel signal using said error signal.

9. The stereo speech decoding apparatus according to claim 8, wherein encoded information in which said error signal is encoded has more bits used the nearer to an end of a frame.

10. A stereo speech encoding apparatus comprising:
a monaural signal generation section that combines a temporally-preceding preceding channel signal and a temporally-succeeding succeeding channel signal of a stereo speech signal composed of two channels to generate a monaural signal;
a monaural signal encoding section that encodes said monaural signal;
an onset position encoding section that encodes an onset position at which a change is made from an inactive speech section to an active speech section of said stereo speech signal;
a delay time difference encoding section that encodes a delay time difference between said preceding channel signal and succeeding channel signal; and
an amplitude ratio encoding section that encodes an amplitude ratio between said succeeding channel signal and said preceding channel signal.

11. The stereo speech encoding apparatus according to claim 10 wherein said delay time difference is a delay time difference between a preceding channel signal and succeeding channel signal in one frame overall, further comprising:
a calculation section that divides said one-frame preceding channel signal and succeeding channel signal into a plurality of sections with said delay time difference in one frame overall as a length, calculates a delay time difference in said each section between divided said preceding channel signal and said succeeding channel signal, and calculates a fluctuation amount of a delay time difference in said each section with respect to said delay time difference in one frame overall as a delay time difference correction value in said each section; and
a delay time difference correction value encoding section that encodes said delay time difference correction value in each section.

12. The stereo speech encoding apparatus according to claim 11, wherein said calculation section calculates a difference between said delay time difference in one frame overall and said delay time difference in each section as said delay time difference correction value in each section.

13. The stereo speech encoding apparatus according to claim 11, wherein said delay time difference correction value encoding section uses more encoding bits in encoding of said delay time difference correction value in said each section the nearer to an end of a frame.

14. The stereo speech encoding apparatus according to claim 10 wherein said amplitude ratio is an amplitude ratio between a preceding channel signal and succeeding channel signal in one frame overall, further comprising:
a calculation section that divides said one-frame preceding channel signal and succeeding channel signal into a plurality of sections with said delay time difference in one frame as a length, calculates an amplitude ratio in said each section between said preceding channel signal and said succeeding channel signal, and calculates a fluctuation amount of an amplitude ratio in said each section with respect to said amplitude ratio in one frame overall as an amplitude ratio correction value in said each section; and
an amplitude ratio correction value encoding section that encodes said amplitude ratio correction value in each section.

15. The stereo speech encoding apparatus according to claim 14, wherein said amplitude ratio encoding section calculates a ratio between said amplitude ratio in one frame overall and said amplitude ratio in each section as said amplitude ratio correction value in each section.

16. The stereo speech encoding apparatus according to claim 14, wherein said amplitude ratio correction value encoding section uses more encoding bits in encoding of said amplitude ratio correction value in a section near an end of a frame than in a section near a start of a frame among said sections.

17. A stereo speech decoding method comprising:
a step of decoding encoded information in which a monaural signal in which a temporally-preceding preceding channel signal and a temporally-succeeding succeeding channel signal of a stereo speech signal composed of two channels are combined is encoded;
a step of decoding encoded information in which an onset position at which a change is made from an inactive speech section to an active speech section of said stereo speech signal is encoded;
a step of decoding encoded information in which a delay time difference between said preceding channel signal and succeeding channel signal is encoded;
a step of decoding encoded information in which an amplitude ratio between said succeeding channel signal and said preceding channel signal is encoded;
a step of decoding said preceding channel signal using said monaural signal, said delay time difference, and said onset position; and
a step of decoding said succeeding channel signal using said preceding channel signal and said amplitude ratio.
